(19) United States
(12) Patent Application Publication
(10) Pub. No.: US 2012/0111190 A1
(43) Pub. Date: May 10, 2012

(54) AIR PURIFICATION AND DECONTAMINATION SYSTEM

(75) Inventors: Nader Dariavach, Middleboro, MA (US); Francis W. French, Harvard, MA (US); Jin Liang, Southborough, MA (US); Joseph A. Ziehler, Carlisle, MA (US)

(73) Assignee: Nader G. Dariavach, Middleboro, MA (US)

(21) Appl. No.: 12/942,017

(22) Filed: Nov. 8, 2010

(51) Int. Cl. B01D 46/46

(52) U.S. Cl. 95/10; 96/397

(57) ABSTRACT

A closed loop air handling system for monitoring and cleaning air from corrosive contaminants. Commonly occurring corrosive elements found in air can react in combination together and with other environmental conditions to increase the propensity for corrosion to occur. The higher corrosive level of air can react with metals causing degradation, wear and often lead to premature failure. This is especially prevalent in environments using forced air convection for cooling, such as data centers. The electronic circuitry is especially vulnerable to such corrosion and requires an environmentally controlled atmosphere with mild corrosiveness for long term reliability. The invention involves circulating the air in a closed loop and monitors and adjusts parameters of active filtration and purification to minimize corrosive agents. The system maintains a milder corrosive environment and better accommodates the use of “free cooling” from outside air for improved energy efficiency and lower carbon emissions. Air quality data is also collected and used to estimate equipment life time expectancy and substantiate warranty claims over exceeding manufacturers recommended environmental operating conditions.

### BACKGROUND OF THE INVENTION

1. Field of the Invention

The invention relates generally to control of air corrosive contaminants commonly found in the heating, ventilation and air conditioning, HVAC, systems in environments consisting of data centers, telecommunication rooms, clean rooms, medical labs and industrial process rooms.

2. Background

Many computer and telecommunication rooms rely on forced air convection to cool the electronic Information Technology (IT) equipment. The power density of the IT equipment has continued to increase, thus requiring more air to cool the equipment. The quality of the air often is not monitored and certain combinations of chemical species along with higher temperature and humidity can accelerate metal corrosion. Certain geographic areas around the world have high concentrations of oxidizers (NO2, O3), sulfur dioxide and other impurities in the air. The increased use of “free cooling” brings outside air directly into the data center, which could be high in impurities and accelerate corrosion rates with the electronic equipment.

Most of the electronic IT equipment available today is designed to be lower cost and made on high volume, robotic assembly lines. The smaller components and increased pitch along with less protective solder mask and cheaper materials exacerbate the formation of creep corrosion. The corrosion can “bloom” and spread to adjacent pin signals and short circuit them. This can lead to hardware failures and potential “data unavailable” (DU), and in some instances “data loss” (DL) errors. To ensure fault tolerance, and serviceability levels, redundant equipment is often required, increasing costs and energy use. The higher failure rate, also leads to increased customer service replacement cost and maintenance.

### SUMMARY OF THE INVENTION

In one aspect, the invention features a method for detecting and reporting levels of air impurities along with operating temperatures and relative humidity levels. The method comprises sending the environmental data from the sensor to the controller and comparing the value in a look up table or algorithm. The look up table or algorithm is based on empirical material science corrosive experiments in a proprietary knowledge base. The knowledge base is used to evaluate the environmental input variables and determine using parameter sensitivity analysis, if the environment is corrosive and requires corrective action to adjust it to within acceptable limits. If so, the controller directs an output action to provide counter measures to optimally reduce the corrosiveness in the air. If no action is required, the system bypasses the neutralization and decontamination process and continues to operate normally in an energy efficient method.

In another aspect, the invention features a neutralization and decontamination filter device that can clean, scrub and add or remove chemical species as required to neutralize the air and to minimize the corrosiveness in the environment. A proprietary algorithm compares the environmental conditions from the sensors and determines which factors should be varied to efficiently adjust the air quality. The filter can use nanotechnology as well as electronic and mechanical filtering techniques to remove harmful impurities from the air. It can also add or remove moisture to the air and change temperature as required.

In still another aspect, the invention features a method to control the temperature and relative humidity of the data center air to operate at optimal conditions for energy efficiency and mild corrosiveness. High temperatures and relative humidity can accelerate corrosiveness when in conjunction with other contaminants in the air. The sensor network is connected to a control unit that includes a microprocessor unit, which can control the computer room air conditioner units (CRAC). The CRAC units will operate normally to maintain desired room settings, but when subjected to high air contaminants, can also be set to run at lower temperatures and humidity levels when needed. The individual CRAC units can also be controlled separately by zones to provide higher granularity of efficiency.

The sensor data can be imported, uploaded and read on commonly available infrastructure software. It can be logged and stored for historical trends and future projections. The communication network can be Ethernet LAN, Fiber channel, wireless or other standard means.

The air quality data can be stored securely and used to verify and substantiate warranty claims with original equipment manufacturers. Many manufacturers have their own acceptable environmental requirements. A sensor can be placed on or near each desired piece of equipment to provide ongoing verification of environmental compliance. Specific areas in the room can be controlled to tighter specifications providing flexibility to meet manufacturers requirements, desired reliability tradeoffs and energy efficiency. The environments can be controlled to meet specifications such as given in ISA 71.04.

In another aspect, the controller can vary the external air damper to permit outside air to enter the building for “free cooling”. If the external air sensor detects high levels of corrosive species and determines that the conditions are out of acceptable limits, it will govern the damper and prevent outside air from entering the building.

In still another embodiment, the outside air entering through the damper can be pre-conditioned directly into the neutralization and decontamination device prior to being mixed with internal air. It can also be directed into an auxiliary gas filtration device to further condition and pre-clean the air prior to mixing with internal air. In certain cases, the air may also need the temperature and relative humidity raised or lowered prior to entering the building.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a flow diagram of an embodiment of a system process for monitoring and adjusting the air cleanliness.

FIG. 2 is a physical block diagram of an embodiment of the system in which aspects of the invention may be implemented.

FIG. 3 is a schematic representation of the communication between a sensor, microprocessor controller and filter device that is used in conjunction with the CRAC unit.

FIG. 4 is a schematic representation of the communication between a sensor, microprocessor controller and filter device that has it's own building air conditioner, but requires a separate air mover to be used in conjunction with the filter.

FIG. 5 is a process control diagram that shows the input and outputs of the process.

### DETAILED DESCRIPTION

Applicants recognized that corrosion of IT equipment is a growing concern around the world, especially in developing countries that have higher amounts of air pollution. In addition, data centers are being legislated to reduce energy consumption and have begun to employ “free cooling”, which involves bringing outside, unfiltered air directly in to cool the equipment. This enables the chillers in the air conditioning equipment to be shut down thus saving energy. The unfiltered air however, can increase the likelihood of added contaminants and humidity that can harm IT equipment.

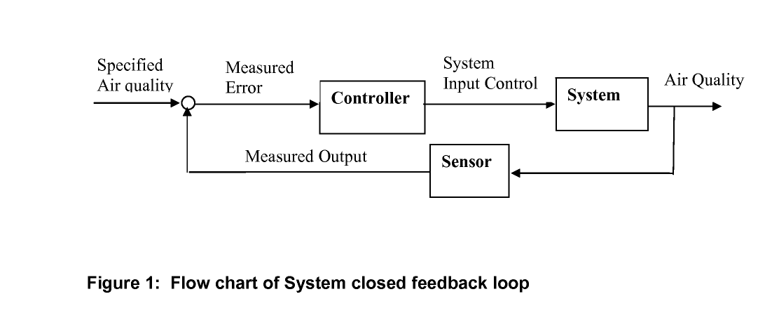

The system can be depicted as a closed loop feedback flow chart as shown in FIG. 1.

The desired air quality inside the building can be set as the limit to reference to. This can be generally accepted standards such as ISA-71.04 or other user determined air quality or corrosion levels. An air sensor measures the air quality and contaminant level in the room and sends the signal to the controller.

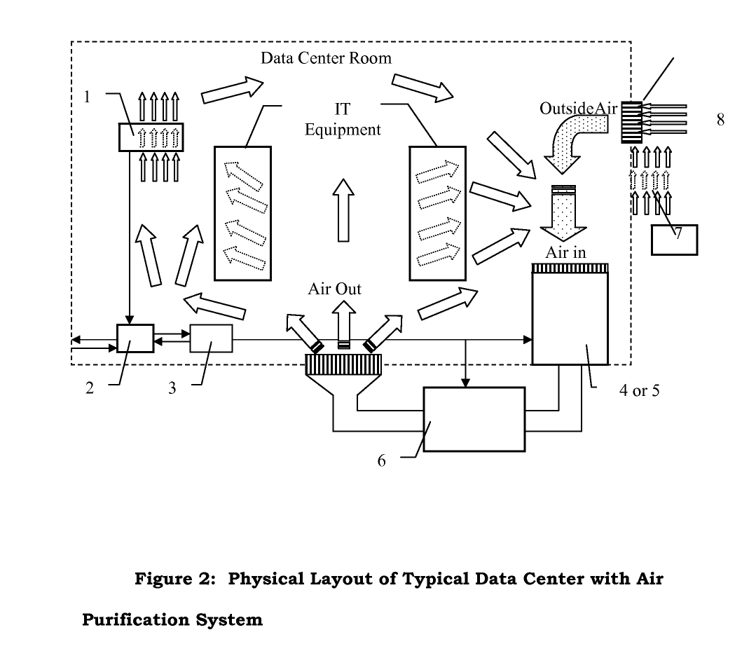

FIG. 2 shows a physical layout of a typical Data Center with one embodiment of the aspects of the air purification and decontamination system. The air sensor unit, 1, can be wall or cabinet mounted within the Data Center. It samples the internal air, detecting temperature, humidity and presence of chemically active contaminations (such as oxidizers (NO₂, O₃), reduced sulfides (SO), sulfur dioxide (SO₂) and other impurities).

It electronically transfers these readings to the Controller, 2, where a microprocessor reads the data and determines if it is within acceptable limits or not. The controller will also log and store the data for user defined purpose and duration.

The controller can communicate and control the operation of the air handling system. An adapter interface, 3, connects the signals from the air handler and filter devices as well as other peripheral devices to the controller. This enables the controller system to connect to existing infrastructure devices. The controller also can communicate to the infrastructure monitoring software via LAN connection and other protocols, including wireless communication. Depending on the outcome of the sensor measurements, the controller will direct the peripheral devices to take corrective action and attempt to bring the air quality back to acceptable limits. The controller can change the operating settings of the computer room air conditioner, 4, to change temperature and/or humidity. If the room has no CRAC unit and a separate air conditioning scheme, a blower device, 5, is substituted to pressurize and move air within the room. The invention can also be installed in rooms that have their own separate or preexisting temperature and humidity controls.

The air chemical decontamination/neutralization, ACDN unit, 6, is generally installed downstream of the CRAC unit and receives high pressure, high volumetric air flow. This helps ensure all air circulating in the room is subjected to the sequestration and helps to reduce the effects of any pressure drop across the device. The controller sends signals to the device to turn on and activate certain chambers to cleanse identified impurities from the air. In the normal off position, the device has a bypass chamber that provides no decontamination or neutralization of the air. In rooms with their own air conditioning controls, the ACDN can run independently. In certain embodiments, an additional air sensor, 7, is installed on the outside of the building to monitor external air quality. Should the air quality be inferior, a warning message can be issued and the controller may limit or prevent the external damper, 8, from opening, depending on customer set limits. If the air quality is deemed acceptable, the controller will enable outside air or “free cooling” to be used. In some cases, the external air can also be pre-conditioned or cleaned prior to entering the building, thus enabling “free cooling” without the harmful effects of impurities or humidity.

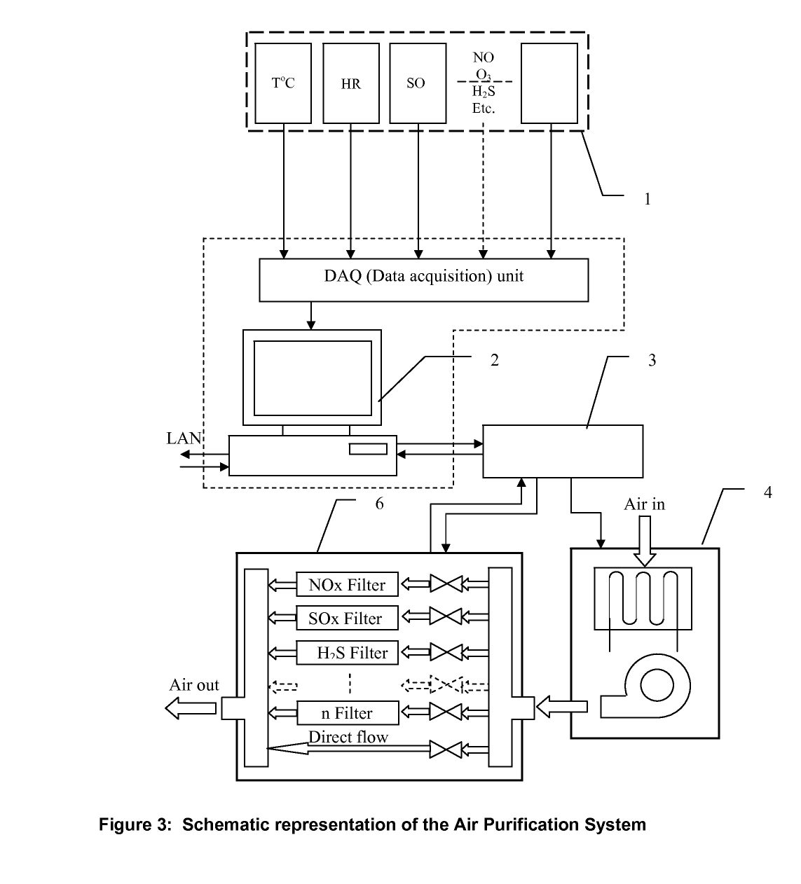

FIG. 3 shows a schematic representation of the communication between the sensors, microprocessor controller, air circulation and filter units. The sensor unit, 1, consists of different types of sensors that are capable of detecting air temperature, humidity levels and low concentration levels of corrosive active contaminants such as oxidizers (NO2,O3), sulfur dioxide and other impurities. The Data acquisition unit converts analog signals from the sensors into digital numeric values and transfers them to the controller unit, 2. A micro processor, in the controller analyzes the data and determines if any corrective action is required. Signals are then sent to the adapter interface unit, which can directly adjust the air conditioning unit 4, and air filter unit, 6.

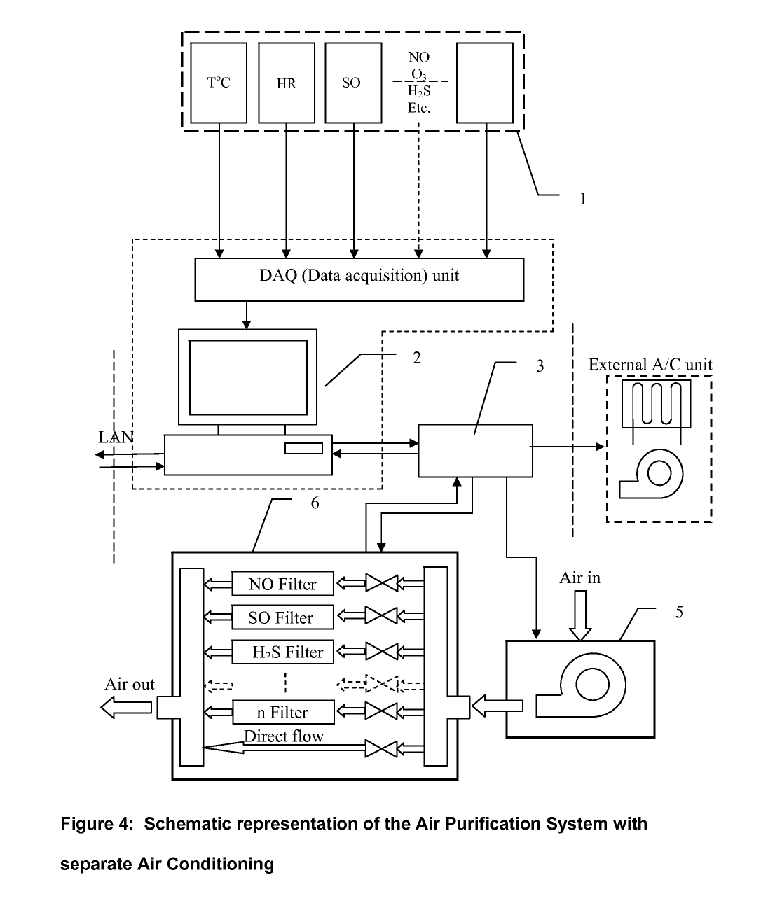

FIG. 4 shows a similar schematic as FIG. 3, except the system uses its own air mover instead of utilizing an existing CRAC unit. The air mover can be part of or separate to the air filter device. This enables an existing air conditioner system to remain independent and not become an integral part of the Air Purification system.

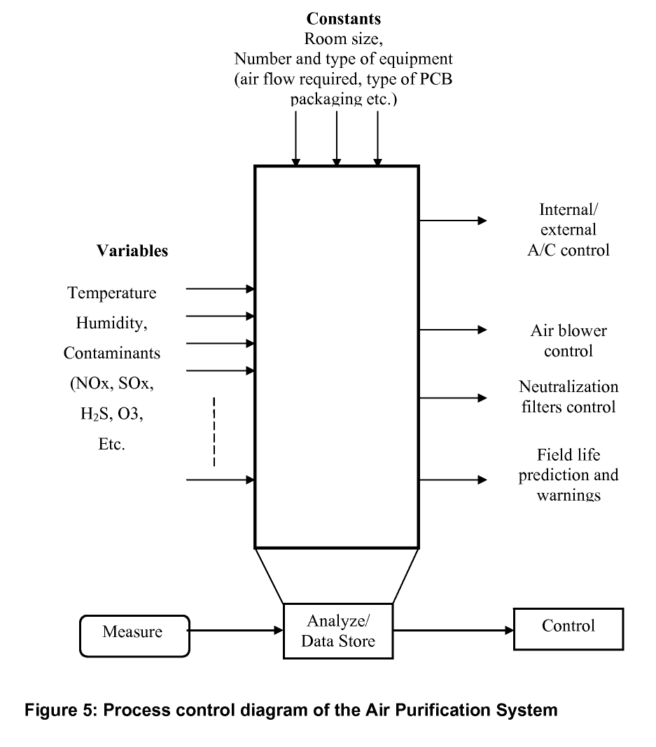

FIG. 5 shows a process control diagram of the Air Purification system. This includes the physical air variables and independent constants that make up the input factors. The output of these input factors are the controlled factors, which enable the Air Purification system to self correct in a negative feedback process.

1. A method for measuring, monitoring and purifying air in a data center or similar clean room environment, the method comprising:
Sensing air species constituents, temperature and humidity;
Read data into a microprocessor;
Compare results to a database algorithm;
Report results to infrastructure monitoring software; and
Signal an alarm if conditions are out of specified limits.
Control and optimize temperature and humidity.
Filter and remove impurities and chemical species from the air as required to minimize corrosion.

2. The method of claim 1, wherein the data can be transmitted, wirelessly or using other protocol, to a receiver and downloaded to 3rd party infrastructure software.

3. The method of claim 1, where the data can be further utilized to control internal ambient conditions and air quality.

4. The method of claim 1, where the data can be further utilized to control an air intake damper to allow outside make-up air for “free cooling” based on pre-determined allowable corrosive limits.

5. A method for filtering air impurities in a data center or similar industrial clean room environment with the intent of maintaining a low corrosive air environment.

6. The method of claim 5, where the filter device can be installed on and retrofitted to an existing 3rd party computer room air conditioner unit, (CRAG).

7. The method of claim 5, to allow easy cleaning and replacement of the filter devices.

8. The method of claim 5, that enables gaseous scrubbing of sulphur compounds, nitrous oxides, chlorinated gases, halogens and other chemical species from the air.

9. A closed loop monitoring and air adjusting system comprising:
a plurality of air sensors;
a plurality of gaseous filters with actuator control;
motor control for outside air dampers;
air movers;
temperature and humidity control;
infrastructure software; and
a microprocessor and controller board in communication with the sensors, filters, dampers and infrastructure software, capable of controlling, monitoring, reporting and storing data.

10. The method of claim 9, enabling logging and reporting data over time for historical and trend data.

11. A secure method of compliance using the method of claim 9, whereby companies can purchase a service for a 3rd party to monitor and certify the corrosiveness of the environment.

12. A risk assessment can be provided from the environmental database software quantifying the additional corrosion exposure for extended excursions beyond the specified limits.

13. A further method of claim 9 where the IT equipment manufacturers corrosion limits can be input into the software and automatically monitored for compliance. A periodic output report can be provided to show if any excursions occurred and the duration.

14. The method of claim 9 whereby a software program that contains an empirically derived database of constituents and factors that based on combinations affect the severity of air corrosion levels in data centers and clean rooms. This database is used as input to control and optimize air quality.

15. A method of claim 9 whereby the sensors can be miniaturized and applied to specific equipment to provide higher resolution and individual profiles.

16. A method whereby warranty claims from IT equipment manufacturers can be validated or arbitrated based on data collected.
